(19) United States
(12) Patent Application Publication
(10) Pub. No.: US 2004/0265519 A1
(43) Pub. Date: Dec. 30, 2004

(54) Fabrication of fluid delivery components

(76) Inventors: Roberto O. Pellizzari, Groton, MA (US); Bennett Sprague, San Francisco, CA (US); Eric J. Carlson, Sudbury, MA (US)

Correspondence Address: BURNS, DOANE, SWECKER & MATHIS, L.L.P., P.O. Box 1404, Alexandria, VA, 22313-1404, US

(21) Appl. No.: 10/607,444

(22) Filed: Jun. 27, 2003

(51) Int. Cl. B32B 1/08; B29C 33/40

(52) U.S. Cl. 428/34.1; 264/81; 264/219

(57) ABSTRACT

Method for forming a fluid conduit comprising (a) molding a template having at least a part thereof corresponding to an internal geometry of the conduit; (b) coating a layer on an exposed surface of the template; and (c) removing the template. A wide variety of conduit shapes can be economically manufactured, including those having small dimensions and high design tolerances. Fluid vaporizing devices, which can be used to deliver fluids and/or generate aerosols including capillary tubes with finished or activated inner surfaces, can be manufactured.

### BACKGROUND

The present invention relates generally to making fluid delivery components that can be used for applications such as aerosol delivery.

Aerosols are gaseous suspensions of fine solid and/or liquid particles. Aerosols are useful in a wide variety of applications. For example, medicated liquids may be administered in aerosol form. Medicated aerosols include materials that are useful in the treatment of respiratory ailments. In such applications, the aerosols may be produced by an aerosol generator and inhaled into a patient's lungs. Aerosols are also used in non-medicinal applications including, for example, dispensing air fresheners and insecticides, and delivering paints and lubricants.

Aerosol generators are known that include a heated tube for vaporizing liquid. For example, U.S. Pat. No. 5,743,251, which is incorporated herein by reference in its entirety, discloses an aerosol generator including a tube and a heater operable to heat the tube to a temperature sufficient to volatilize liquid in the tube. The volatilized material is ejected out of an end of the tube and can be admixed with ambient air to form a condensation aerosol.

Other exemplary aerosol generators, including a heated tube for vaporizing liquids to produce an aerosol, are disclosed in commonly assigned U.S. patent application Ser. No. 09/956,966 filed Sep. 21, 2001 and Ser. No. 10/003,437 filed Dec. 6, 2001, and in U.S. Pat. No. 6,234,167, the disclosure of each being incorporated herein by reference in its entirety.

U.S. Pat. Nos. 5,869,133; 5,011,566 and 4,395,303 disclose methods for manufacturing microscopic tubes as well as objects of non-circular cross-sections. For example, the '133 patent discloses a method for producing a diamond tube on a hollow support mandrel. According to the '566 patent, a coating material such as carbon, a ferrous metal, a non-ferrous metal or a ceramic is deposited onto a microscopic carbon fiber and then the carbon fiber is heated and removed by oxidation leaving a hollow tube. The '303 patent discloses a method for manufacturing metallic objects having thin walls comprised of corrosion resistant materials.

U.S. Pat. Nos. 6,194,066; 6,113,722; 6,059,001; 5,353,512; and 5,298,298 disclose the manufacture of microscopic tubes by depositing a tube material on carbon or glass fibers and then removing the fibers.

There is a need for a method for forming fluid delivery components comprising capillary-sized conduits that are readily connectable with other capillaries, conventional sized tubing and/or other structures. It would also be advantageous to prepare fluid delivery components economically and/or according to high design tolerances. In addition, it would be advantageous to prepare fluid delivery components with a polished or active interior surface, such as a catalytically active interior surface.

### SUMMARY

One embodiment relates to a method of manufacturing a fluid delivery component having a capillary-sized fluid delivery conduit comprising the steps of (i) molding a template having at least a part thereof corresponding to an internal geometry of the conduit; (ii) coating a layer on an exposed surface of the template; and (iii) removing the template to produce the fluid delivery component. According to a preferred embodiment, the template can be injection molded.

The template can be molded to form a conduit comprising at least one segment having a transverse cross section, such as a capillary-sized tube, with an internal dimension less than about 1 mm. The template can be molded to form a conduit comprising a segment having a constant and/or variable cross-section. The template and conduit may include a fluid connection at an upstream end thereof and an outlet optionally configured with a nozzle at a downstream end thereof. The template and conduit may include a branched flow passage, a flange, a bend and/or electrical connections.

According to preferred embodiments, at least a portion of the template can be hollow and the template can be cleaned or conditioned before the template is coated. The template can comprise a plurality of first sections wherein each of the first sections has the internal geometry of the conduit and a plurality of second sections that extend from at least one end of the first sections. Preferably, the template is formed from a polymer material, a low melting temperature metal or an electrically conducting solid.

The template can be formed from a polymer such as thermoplastics, fiber reinforced thermoplastics, thermosetting plastics, cellulose esters, polyesters, co-polyesters, elastomers and mixtures thereof. Exemplary polymers include acrylonitrile butadiene styrene (ABS), acetals, acrylics, polycarbonates, polyesters, polyethylene, fluoroplastics, polyimides, Nylon, waxes, fatty esters, polyphenylene oxides, polypropylenes, polystyrenes, polysulphones and polyvinyl chlorides.

The template can be formed from a metal or alloy have a low melting point, such as aluminum, zinc, silver, indium, tin, lead and mixtures thereof, including solders, brazes and the like.

According to an embodiment, the template comprises an insert that passes through at least a portion of the template. The step of removing the template can include heating the insert.

The layer deposited on the template can be deposited to a total thickness of about 50 to 1000 microns and can comprise a single material or two or more materials. Preferably, the layer comprises an activated layer material and/or a structural layer material. According to an embodiment, the step of removing the template includes heating the layer.

An activated layer material can be deposited using sputtering, chemical vapor deposition, plasma deposition, electroless plating, electroplating, dip-coating and electrophoresis to a total thickness of from about 1 to 100 nm and can comprise cobalt, nickel, copper, rhodium, palladium, silver, iridium, platinum, gold and alloys or combinations thereof. According to preferred embodiments, the activated layer material forms an inner surface of the conduit and can comprise a catalytically active material.

The structural material can be deposited using sputtering, chemical vapor deposition, plasma deposition, electroless plating, electroplating, dip-coating and electrophoresis to a total thickness of from about 50 to 1000 microns and can comprise a metal, metal alloy and/or ceramic material. Preferably, the structural material is nickel. The structural material can also comprise two or more layers of different materials.

After deposition of the layer or layers on the template, the template can be removed by any suitable technique such as by high temperature burn-out, de-polymerization, salvation, melting, etching or pyrolysis.

According to a preferred embodiment, a fluid vaporizing device is assembled with the conduit of the fluid delivery component forming a flow passage for delivery of vaporized fluid. The fluid vaporizing device can include a liquid source in fluid communication with the flow passage by way of a fluid connection attached to a connection at an upstream end of the conduit. Electrical connections can be attached to the conduit to form a heater from a resistively heated section of the conduit. A power source can supply electrical power to the heater and thereby heat liquid in the heated section of the flow passage to produce a vapor. A nozzle at the outlet end of the fluid vaporizing device can be configured (i) to increase the exit velocity of the vapor such that a mass median aerodynamic diameter of aerosol particles is decreased or (ii) to decrease the exit velocity of the vapor such that the mass median aerodynamic diameter of aerosol particles is increased. The nozzle and/or flow passage can have a variable cross-sectional flow area and the cross-sectional flow area of the nozzle can vary continuously or non-continuously along the length of the nozzle.

### BRIEF DESCRIPTION OF THE DRAWINGS

The following detailed description makes reference to the accompanying drawings, in which:

FIG. 1 shows a side-fed fuel injector having a capillary tube coiled around the injector body.

FIG. 2 is a schematic of an injection molding apparatus.

FIG. 3 illustrates capillary tube configurations that can be manufactured according to one embodiment.

FIG. 4 shows a template frame for forming a plurality of conduits.

FIG. 5 illustrates a capillary tube including a nozzle having an enlarged cross-sectional area.

FIG. 6 illustrates a capillary tube including a nozzle having a reduced cross-sectional area.

FIGS. 7-8 illustrate a one-piece capillary tube including a nozzle.

FIG. 9 illustrates a capillary tube including two electrodes.

### DETAILED DESCRIPTION OF THE PREFERRED EMBODIMENTS

Provided are methods for manufacturing fluid conduits having capillary-sized dimensions. The fluid conduits are useful in a variety of applications. A preferred application is fluid delivery of liquids such as medicated solutions for aerosol delivery or fuel to be combusted. It is contemplated that the fluid conduits can be made with complex configurations. For example, the fluid conduits can include fluid connections and/or branched flow passages. The method provides a technique by which mass production of such complex parts can be carried out with precise dimensions and/or minimal post-processing.

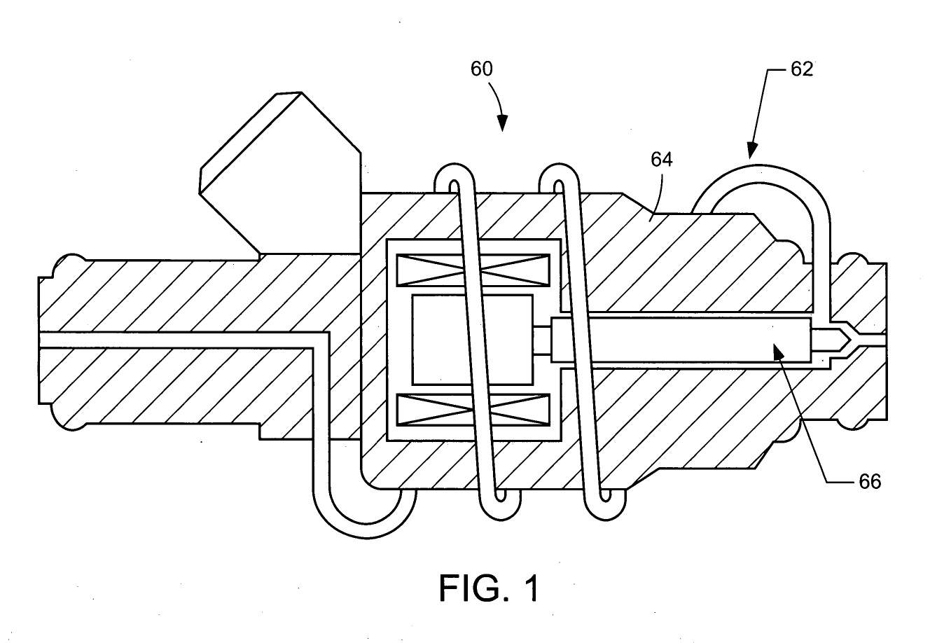

According to the method, a fluid conduit can be made by molding a template, depositing material on exposed surfaces of the template to form the fluid conduit, and then removing the template. According to a preferred embodiment, the template can be injection molded and can be made from plastic, metal or a metal alloy and can be removed from the overlying conduit material by chemical, thermal or other suitable technique. The conduit can be used in applications for gas and/or liquid transport, including aerosol generation or for vaporizing fluid in a fluid vaporizing device. For instance, the fluid vaporizing device can be used for aerosol generation in medical applications, e.g., hand held inhalers, or as a fuel vaporizer in combustion engines, e.g., automobile engines or micro-scale combustion systems. An illustration of a side-fed fuel injector 60 having a heated capillary tube 62 coiled around the injector body 64 is shown in FIG. 1. The capillary tube vaporizes liquid fuel and injects fuel vapor into the side of the injector 60 at the pintle 66. Upon exiting the capillary tube at the pintle, the fuel vapor may form an aerosol.

A template having the configuration of the fluid conduit can be molded or cast directly or post-molding/casting processing can be used to create asymmetrical geometries that may be difficult to make directly from a mold because of geometric restrictions.

The template can be molded in a shape that corresponds to a capillary-sized flow passage having one or more sections of constant or variable dimension with or without a nozzle at the outlet thereof and/or a fluid connection at an inlet end thereof. The shape and dimensions of the template can control the shape and dimensions of the final component. By controlling the shape and dimensions of the final component, it is possible to control performance characteristics such as fluid flow and temperature profiles.

If desired, the template may include a shaped section at an upstream end of the capillary flow passage, the shaped section having a configuration that permits a mechanical connection of a fluid source to the fluid conduit which remains after removal of the template. For applications where the conduit is used to heat fluid, electrical connections can be formed along the tube to allow electrical current to resistively heat a portion of the conduit.

Injection molding, for example, can be used to form templates having a wide variety of shapes and dimensions from a wide variety of materials. Using injection molding, a plurality of interconnected templates having the same or different configuration can be injection molded in a single injection molding step.

Many metals may be injection molded, including aluminum, zinc, silver, indium, tin, lead and mixtures thereof. Many polymers can be injection molded, including thermoplastics, fiber reinforced thermoplastics, thermosetting plastics, cellulose esters, polyesters, co-polyesters, elastomers and mixtures thereof. Structural injection molding is also possible in which a core and skin may be made of different materials. Reaction injection molding and liquid injection molding involve the injection of liquid polymer systems that polymerize within the mold.

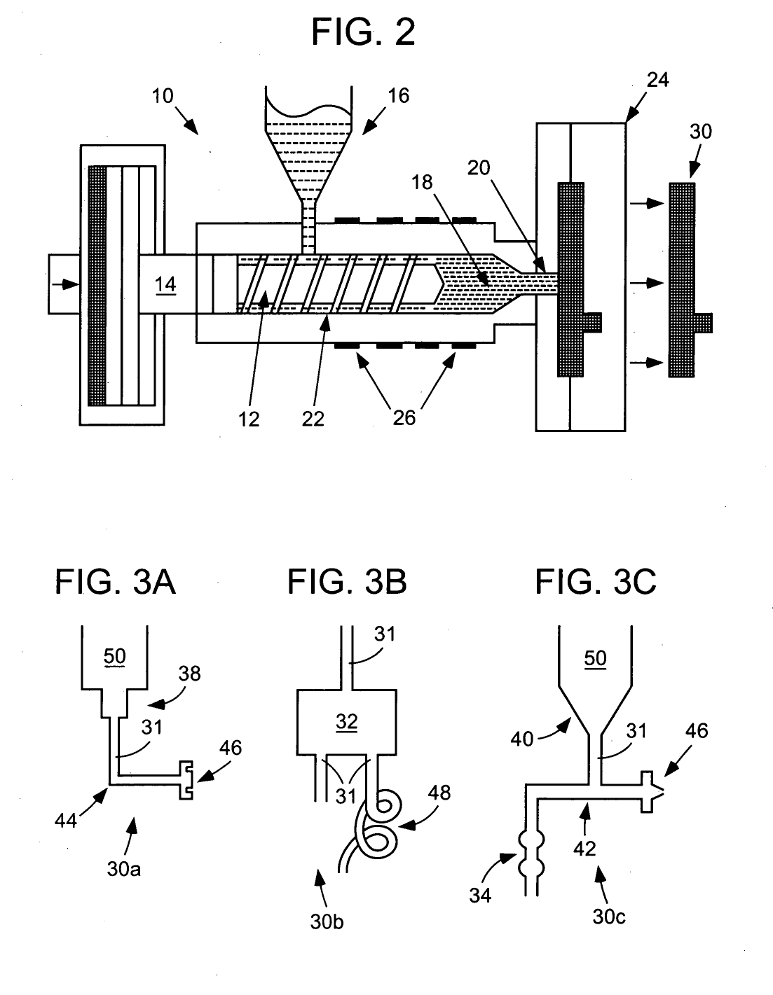

Injection molding machines consist of two basic parts, an injection unit and a clamping unit. The injection unit, which is conventionally screw fed or ram fed, melts the metal or polymer and injects the melt into the hollow mold cavity. FIG. 2 is a schematic of an injection molding machine 10 that illustrates both screw and ram fed systems. The screw fed injector uses a rotating and axially reciprocating screw 12 that moves within barrel 22 to mix, melt and pump the template material 18 from a feedstock source 16 through a nozzle 20 and into a mold 24. Barrel 22 is equipped with heaters 26 that melt the template material. In the screw type injector, the screw rotates forward and fills the mold 24 with melt 18 and holds the melt under high pressure. With the injection molding of polymers, the screw can add more melt to compensate for the contraction due to cooling and solidification of the melt. Rotation of the screw can be produced by a hydraulic motor (not shown). In the ram fed type injector, a plunger 14 pushes the metal or polymer through a heated region of barrel 22 where it is melted. Commonly, the melt is then spread into a thin layer to allow for better contact with the heated surfaces. The melt converges at the nozzle 20 and is injected into the mold 24. The ram in the ram fed type injector can also be hydraulically powered. In both types of injectors, a valve or gate (not shown) positioned at the nozzle can prevent back flow of the melt from the mold cavity. A gate is an inlet port to the mold cavity.

During the injection molding process, molten metal or polymer flows from the nozzle to the mold through a single gate or multiple gates. For example, in a mold with multiple cavities, the melt flows to each cavity by runners and is fed to the mold through a plurality of gates. Each gate is a restriction in the flow path just ahead of the mold and serves to direct the flow of the melt into the cavity and to limit back flow.

The second basic part of an injection molding machine is the clamping unit (not shown), which holds the mold 24 together and can automatically open and close. The clamping mechanism may be of several designs, either mechanical, hydraulic or hydro-mechanical. After the melt that has been injected in the mold has cooled, the mold 24 is opened and the molded template 30 is removed.

The injection molding cycle comprises the steps of melting the metal or polymer, injecting the melt into a mold, cooling the mold, and removing the solidified part or template. Typical cycle times can range from 10 to 100 seconds and are usually controlled by the cooling time of the metal or thermoplastic or the curing time of the thermosetting plastic.

The molded template is coated with one or more layers of material which form the fluid delivery component after removal of the template. Because the template is removed, the metal or polymer used for the template preferably has a removal rate that is higher than the material used to form the component. For example, the coated template can be placed in a solvent or reactive environment wherein the template material is removed while minimizing removal of the component material.

In one embodiment, metals used in injection molding the template comprise electrically conductive metals. Advantageously, a metallic template that is electrically conductive is amenable to electroplating the component material. Electroplating is one example of a cost-effective deposition process. As discussed in more detail below, however, the component material can also be deposited by other techniques such as CVD, sputtering, dip-coating or electroless deposition.

Metals used to form the template can preferably include low melting point metals and/or alloys, such as aluminum, zinc, silver, indium, tin, lead and mixtures thereof, including solders, brazes and casting alloys (e.g., whitemetal, pot metal, zamac, kirksite, and the like). A low melting point metal or alloy has a melting temperature less than about 1000° C., preferably less than about 500° C.

In another embodiment, the template comprises a polymer material. A polymer material can comprise waxes, fatty esters, hydrocarbon polymers and mixtures thereof. For example, SDI AccuProp™, which has a melting point between about 47 to 63° C., is a blend of waxes, fatty esters and hydrocarbon polymers available from Sanders Design International (Wilton, N.H.). Polymer materials used in injection molding can be classified as amorphous, semi-crystalline, blended and filled. In an amorphous polymer, the polymer chains are randomly distributed. Examples of amorphous polymers include polycarbonates, polyphenylene oxides and acrylonitrile butadiene styrenes. In a semi-crystalline polymer, the polymer chains are partially ordered and can form crystallites. Examples of semi-crystalline polymers include polybutylenes and terephthalates.

In a further embodiment, the template comprises a thermoplastic material. Thermoplastic compounds which can be used in injection molding include acrylonitrile butadiene styrene (ABS), acetals, acrylics, polycarbonates, polyesters, polyethylene, fluoroplastics, polyimides, Nylon, polyphenylene oxides, polypropylenes, polystyrenes, polysulphones and polyvinyl chlorides.

The template material can comprise blends of materials. For example, engineering polymers can be blends of two or more polymers. Polymer blends can be prepared, for example, in a twin screw extrusion apparatus, which can combine two or more polymer sources in a common melt. Fillers such as short glass fibers, coloring agents, fire retardants, etc. can be added to polymers to enhance their performance characteristics. For example, filled polymers can display very low shrinkage and are well suited for injection molding where high design tolerances are desired. In addition to filled polymers, amorphous polymers can also display low levels of shrinkage, while the shrinkage of semi-crystalline polymers and blends is typically higher.

Amorphous polymers typically display lower shrinkage than semi-crystalline polymers because the polymer chains in an amorphous polymer cannot order and fold below its freezing point. The absence of these interactions can lead to a smaller difference in specific volume between the melt phase and the solid phase for amorphous polymers. Also, the presence of fillers like talc or short glass fibers can reduce the difference in specific volume between the melt phase and the solid phase.

The specific volume of a polymer is defined as volume per unit mass (V=v/m). The specific volume changes with temperature and pressure, and the pressure-volume-temperature (PVT) behavior of a polymer system can play a role in both the processing and dimensions of the final template.

During the processing of polymeric materials, the equilibrium volumetric expansion is a fundamental thermodynamic property of the material and reflects transitions as the material moves between phases. The shrinkage of a molded plastic part, for example, can be twenty percent by volume or greater when measured between the processing and ambient temperatures, which can affect the dimensional precision of the final part.

The physical properties of the polymer can influence the thermal processing window. The temperature for injection molding preferably lies in the range between the glass transition temperature and the degradation temperature of the polymer. Nylon, for example, has a glass transition of 240° C. to 265° C. and degradation occurs at temperatures above about 350° C. or 400° C. Thus, the preferred injection molding temperature for Nylon is typically in the range of about 270° C. to 305° C.

In both part and mold design, geometric parameters include the wall thickness or critical dimension of the part; the number, location, thickness, type and area of gates, and mold constraints from ribs, bosses and inserts.

The choice of wall thickness/critical dimension is primarily governed by the cooling time, flow length and dimensions of the template. For example, the deflection δ of a part under load decreases with increasing wall thickness h according to δ˜1/h³. A ribbed part can meet stiffness specifications with a lower wall thickness. Preferably, the molded template is a rigid, self-supporting structure. The template for capillary-sized fluid delivery components used in aerosol delivery is preferably shaped to include at least a tubular section having an inner diameter of 1 mm or less.

For the injection molding of templates having complex shapes, the gate(s) should generally be located at thicker sections of the template and should allow expulsion of air from the mold during filling. Gates should be sized small enough that they freeze off after sufficient packing, but turbulent flow or jetting of the melt should be minimized. The gate thickness can be about 50% to 75% of the critical dimension of the molded template.

Multiple gates may be used to control the pressure distribution within the mold cavity and to ensure complete filling. Gate locations and the number of gates can also affect the severity and location of weld lines (where two metal or polymer flows meet within the mold). Weld lines can be transferred to the inner wall of the conduit and can affect fluid flow within the capillary flow passage. Thus, it is preferred to avoid the formation of weld lines along fluid flow paths in the fluid delivery component.

The use of multiple gates has several advantages. Multiple gates can advantageously reduce the limitation in flow length imposed by machine pressure and gate area. Multiple gates can reduce pressure gradients inside the template, which in turn can reduce the tendency for non-uniform shrinkage. They can also reduce the cycle time, which can increase the production rate. Finally, multiple gates can enable the formation of molded templates with variations in thickness or critical dimension and thus, multiple gates can be used to form complete fluid delivery components for aerosol delivery wherein part of the molded template corresponds to a fluid connection and another part corresponds to a heated capillary flow passage.

Additional injection molding parameters include fill time, packing pressure, melt temperature and mold temperature. For example, excessive packing may result in a highly stressed molded template and may cause ejection problems, whereas insufficient packing can cause poor surface, sink marks, welds and non-uniform shrinkage.

According to a preferred embodiment, the template can be molded with sections forming reverse images of different parts of a fluid delivery component. The template can be prepared in a single molding step thereby providing economic as well as design advantages. Rather than forming and joining separate template pieces, a complex template molding can meet uniformity and design tolerance specifications because critical dimensions can be built into the mold.

The template can be formed having various segments with different dimensions. FIG. 3 illustrates templates 30a, 30b, 30c having several capillary tube configurations. Template 30a comprises a large diameter tube 50 with a telescoped end 38 connected to capillary tube 31. Capillary tube 31 comprises an elbow 44 and flange 46. Template 30b comprises a manifold 32 connected to capillary tubing 31. Capillary tube 31 comprises a helical segment 48. Template 30c comprises a large diameter tube 50 with tapered end 40 connected to capillary tube 31. Capillary tube 31 comprise a tee 42, flange 46 and segment having a variable cross section 34. Each of these exemplary conduit configurations can be manufactured and integrated as part of a single molded template, without the need for brazing, soldering, welding or gluing together individual template segments. Also, because the smaller diameter capillary tubing 31 can be joined in situ with larger diameter tubing 50, connectors and/or flanges 46, a fluid delivery component can be made which obviates joining capillary tubing with larger sized parts. This is economically advantageous because making connections directly to small diameter tubing can be problematic and time-consuming.

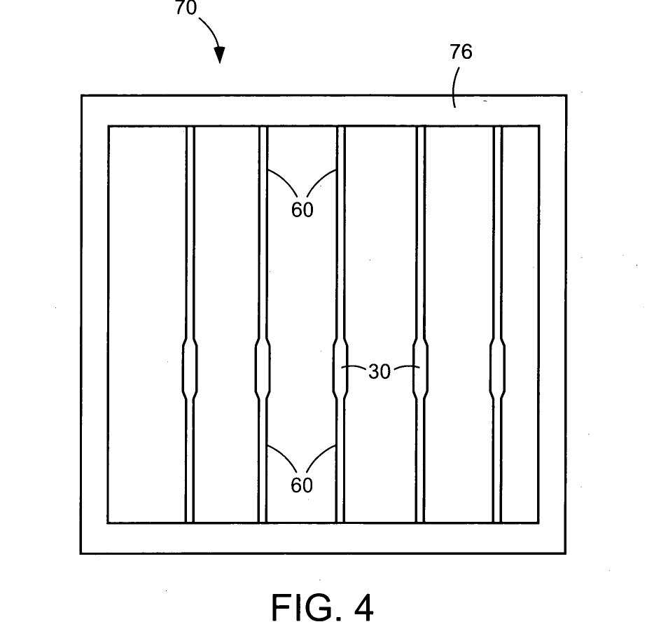

According to a further embodiment, a template comprising the internal geometry of more than one conduit or fluid delivery component to be manufactured can be prepared in a single molding step. As illustrated in FIG. 4, a mass production template 70 comprises templates 30 with gate sections 60 connected to frame 76. The mass production template can comprise more than one identically-shaped template or a plurality of differently-shaped templates that can be molded in a single molding step and coated in a single coating step. In the manufacture of more than one fluid delivery component, the mass production template can be used to produce templates having a simple or complex geometry.

In addition to molding a template with a desired macroscopic geometry and configuration, it is possible to mold a template with a desired surface texture or roughness. The surface finish of the template can be transferred to the inner surface of the fluid delivery component. Thus, it is possible to make capillary tubing having a smooth or rough inner surface. For example, a roughened inner surface can affect the vaporization of liquids passing over the surface by providing nucleation sites that can promote vaporization. A roughened surface also has a higher surface area than a smooth surface, which can be advantageous in combination with a fluid conduit having a catalytic or reactive inner surface. A catalytic surface may advantageously limit the rate of residue formation and/or promote residue removal from the inner surface. A catalytic surface may also promote liquid phase reactions such as where different reactive liquids are mixed within the fluid delivery component. The surface texture of the template can be modified during the molding of the template or after the molding step.

After the step of molding the template, the shape of the template may be optionally modified before the step of coating a layer on an exposed surface of the template. Certain configurations such as helical tube shapes, which can be difficult to obtain directly via injection molding, may be obtained by re-shaping the as-molded shape of the template.

Once the template is formed, the fluid delivery component material is deposited on the exposed surfaces of the template. The fluid delivery component comprises at least one capillary-sized fluid conduit. Fluid delivery components and conduits can be formed from any suitable material including metals, polymers, ceramics and composites and alloys thereof. Furthermore, the fluid delivery component material can be deposited by any suitable technique, including CVD, sputtering, spraying, dipping, electroless deposition, electroplating, electrophoresis, etc. The combination of the underlying template material and the overlying fluid delivery component material(s) are preferably selected such that the underlying template material can be selectively removed after deposition of the overlying layer(s). That is, the removal rate of the template material should be higher than the removal rate of the fluid delivery component material(s) such that the template can be selectively removed from the fluid delivery component without damaging the component.

A preferred conduit is a capillary tube of an aerosol generating hand held inhaler. Because the internal surface finish of the capillary tube may have an impact on its performance, prior to depositing the fluid delivery component material(s) the exposed surface of the template can be cleaned or pre-treated. Surface treatment of the template can be used to improve adhesion, roughness and/or microstructure of the interior surface of the conduit. Pretreatment can also be used to make removal of the template easier. For example, the deposition of a porous layer on the template can allow the flow of solvent along the interface between the template and the inner surface of the fluid delivery component, which can reduce the time required to remove the template.

While conventional surface finishing processes like electro-polishing are difficult to perform on the inside of small diameter capillary tubes, the method described above enables the formation of fluid conduits having a high quality internal surface finish.

Single or multiple layers of fluid delivery component material can be deposited to any suitable thickness. The total wall thickness of the component or conduit, for example, can be from about 50 to 1000 microns. According to a preferred embodiment, an active layer or seed layer, which can form the inner surface of the fluid delivery component, can be applied before the application of a wall-forming or structural overlayer. The active layer can be, for example, a catalytically active layer such as a noble metal. The active layer can also function as a seed layer for the deposition of the overlayer. For example, if the template material is electrically insulating and the active layer is electrically conducting, the active layer can serve as a conductive layer for electroplating of the structural overlayer.

During or after the deposition of a layer on a surface of the template, conventional techniques such as masking and etching can be used to vary the thickness and/or location of the fluid delivery component material. By way of example, a layer, such as a catalytically active layer and/or a structural layer, can be deposited to a constant or varying thickness over all or a portion of an exposed surface of the template.

Multiple layers can be used to enhance the performance or to reduce the cost of manufacturing the fluid delivery component. A more expensive active layer, such as gold or platinum, can be deposited via CVD or sputtering as a very thin inner layer. A less expensive structural layer, such as nickel, iron or stainless steel, can then be deposited on the inner layer using a more economical deposition approach like electroplating. By way of example, an activated layer such as a platinum layer can be deposited on a template by a suitable means such as by CVD to a layer thickness of about from about 1 to 100 nm, a first structural layer such as a nickel layer can be deposited on the platinum layer by a suitable means such as electroplating to a thickness of from about 50 to 1000 microns, and a second optional structural layer such as a ceramic layer (e.g., aluminum oxide) can be deposited on the nickel layer by a suitable means such as electrophoresis to a thickness of about 50 to 1000 microns.

Exemplary mechanisms for the removal of a template include high temperature burn-out, depolymerization, solvation, melting, etching and pyrolysis. A gas phase reaction with air or oxygen, dissolution in an appropriate solvent, or exposure to an energy source such as heat or radiation can be used to remove a polymer template. For example, Nylon is soluble in phenols and in weak organic acids. Acrylics are soluble in dilute bases and acetates are soluble in methylene chloride. A metallic template can be removed, for example, by thermal treatment above the melting temperature of the metal or by treating the metal template in a suitable acid.

Removal of the template material may be carried out in any suitable medium, such as a bath (e.g., solvent bath or acid bath), oven (e.g., vacuum oven) or furnace. According to one embodiment, the template is formed with a hollow configuration. By coating the exterior surfaces of a hollow template, the removal rate of the template can be enhanced. A hollow template can permit a gaseous or liquid reagent used to remove the template to continuously pass through the interior of the template and over a larger surface area of the template material. Thus, a hollow template provides a continuous removal path for template material. Also, the hollow template can accommodate solvent-induced swelling of a polymer template during the removal step, which can reduce stresses on the overlying fluid delivery component material.

The template can also be molded with an insert such as a wire, thread, or the like. An insert molded within the template can impart structural rigidity to the template and/or can allow post-molding re-shaping of the template. An insert molded within the template can also be used to remove the template after coating a layer of material on the template. For example, before or after depositing a layer material on the template, an insert can be physically or chemically removed from the template to create a hollow or partially hollow template. As discussed above, the removal of a hollow template can be easier to accomplish than the removal of a solid template. An insert can also be used to remove the template material after depositing one or more layers on the template. For example, by directly heating the insert or by passing an electric current through an electrically conductive insert, a polymer or low melting temperature metal template material can be heated to above its melting point and removed. The insert is preferably an electrically conducting solid such as a metal (e.g., aluminum or copper) or graphite.

In a preferred embodiment, the template is one of many templates supported by a template frame. After coating the templates with the fluid delivery component material, the individually coated templates may optionally be detached from the frame prior to the step of removing the template from the fluid delivery component material. By detaching the coated template from the frame, the template material can be exposed and the removal rate of the template material can be enhanced. A detached coated template has a removal path for the template material that is shorter than for an attached coated template.

According to a further embodiment, the step of removing the template can include heating the overlying fluid delivery component material. For example, a polymer or low melting temperature metal template material can be heated to above its melting point and removed by directly heating the fluid delivery component material or by passing an electric current through an electrically conductive fluid delivery component material. If heating is done by passing an electric current through an electrically conductive fluid delivery component material, the electrical resistance of the fluid delivery component material can be controlled by varying the thickness and/or composition of the fluid delivery component material. By controlling the resistance of the fluid delivery component material, the temperature profile and removal rate of the template material can be controlled.

In a preferred embodiment, the method can be used to manufacture a fluid conduit of a fluid vaporizing device. The fluid vaporizing device can have different constructions and sizes and can be used to produce vapors or aerosols having different particle sizes making it suitable for different applications. For example, for drug delivery to the human lung, the desired mass median aerodynamic diameter (MMAD) of an aerosol depends on the portion of the lung to which the aerosol is desired to be delivered. Generally, aerosols having a smaller MMAD are capable of deeper lung penetration than aerosols having a larger MMAD. The fluid vaporizing device can produce aerosols having a controlled particle size that is effective to efficiently deliver drug formulations to selected regions of the lung.

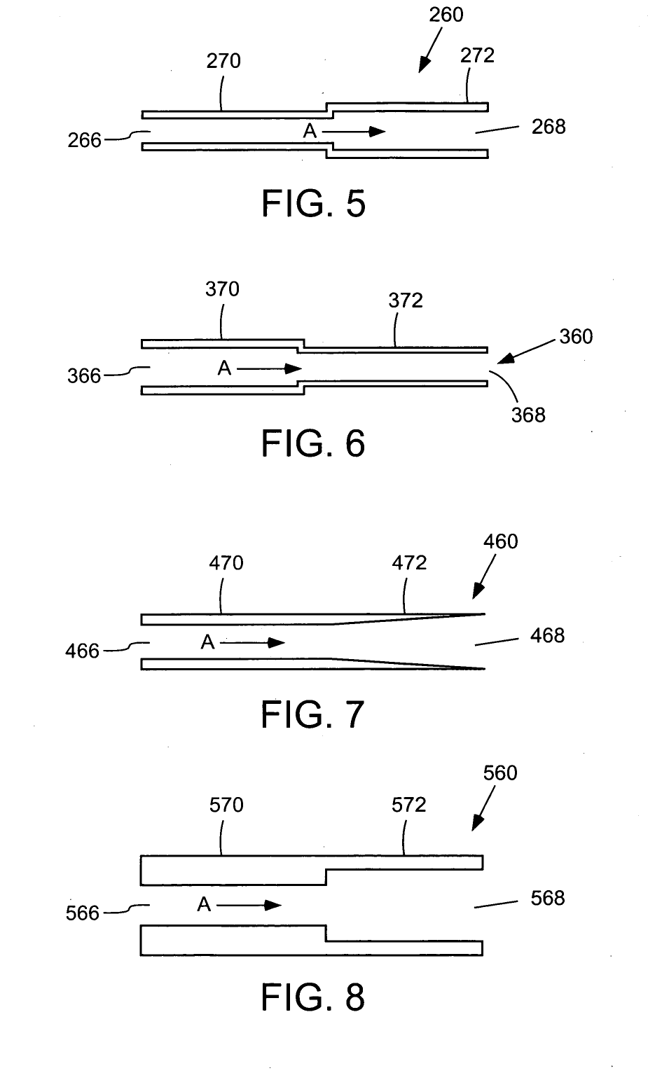

FIGS. 5-8 illustrate several embodiments of conduits 260, 360, 460, 560, respectively. Conduit 260 includes an inlet end 266, an outlet end 268, a first section 270 and a nozzle 272. The size and shape of the nozzle can affect the velocity of the vapor exiting the outlet end of the conduit. The particle size of an aerosol generated by the fluid vaporizing device can be controlled by varying the exit velocity of the vapor. The conduit can have different transverse cross-sectional shapes, such as round, oval, triangular, square, rectangular, other polygonal shapes, or the like, as well as other non-geometric shapes. Different portions of the conduit can have different cross-sectional shapes. The size of the conduit can be defined by its transverse cross-sectional area. For a conduit having a round cross-section, the size of the flow passage may be defined by its diameter. Alternatively, the conduit may be non-circular in cross section and the size of the conduit may be defined by its width. For example, the conduit can have a maximum width of 0.01 to 10 mm, preferably 0.05 to 1 mm, and more preferably 0.1 to 0.5 mm. Alternatively, the conduit can be defined by its transverse cross sectional area, which can be 8×10⁻⁵ to 80 mm², preferably 2×10⁻³ to 8×10⁻¹ mm², and more preferably 8×10⁻³ to 2×10⁻¹ mm². According to one embodiment, the nozzle 272 can have a larger cross-sectional area than the first section 270 of the conduit 260. The nozzle can have the same or a different cross-sectional shape than other portions of the conduit. For example, conduit 260 has a round cross-section, and the nozzle 272 has a larger diameter than the first section 270. Accordingly, as liquid travels downstream and is vaporized in the conduit 260 in the direction from the inlet end 266 to the outlet end 268 (as indicated by arrow A) the vapor moves through the first section 270 at a first velocity and then into the nozzle 272. In the nozzle 272, the velocity of the vapor is reduced to a lower velocity than in the first section 270 by the nozzle 272 having a larger cross-sectional area than the first section 270.

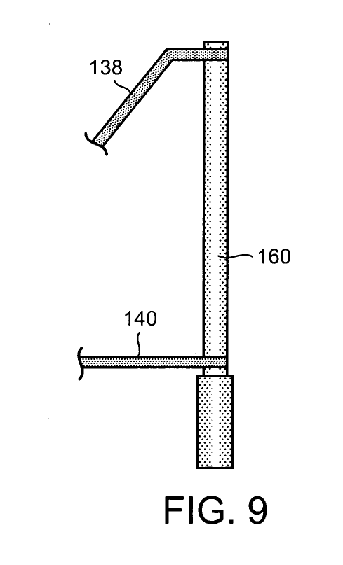

The nozzle can have a smaller cross-sectional area than the first section of the conduit. For example, the conduit 360 shown in FIG. 9 includes an inlet end 366, an outlet end 368, a first section 370 and a nozzle 372. The nozzle 372 has a smaller cross-sectional area than the first section 370. Accordingly, the nozzle 372 increases the velocity of the vapor to a higher velocity than it has in the first section 370 as the vapor moves in the direction indicated by arrow A.

Accordingly, by selecting the cross-sectional area of the nozzle, the exit velocity of the vapor from the conduit can be controlled by either increasing or decreasing the vapor velocity to a desired velocity. Consequently, the particle size of aerosol produced from vapor by the fluid vaporizing device can also be controlled.

The conduit can have more than two sections having different cross-sectional areas from each other (not shown), i.e., more than one section that acts as a nozzle relative to the adjacent upstream section as the fluid moves through the conduit. For example, the conduit can include three sections having different cross-sectional areas from each other. Thus, the cross-sectional area of the conduit can decrease or increase in size from the first section to the second section, and decrease or increase in size from the second section to the third section, i.e., the exit nozzle. Accordingly, the velocity of the fluid is changed (increased or decreased) as the fluid moves from the first section into the second section, and then changed again (increased or decreased) as it moves from the second section into the third section. The exit velocity of the vapor is controlled by the cross-sectional area of the third section.

In conduits 260, 360 shown in FIGS. 5 and 6, the cross-sectional area of the first section 270, 370, respectively, is constant along its length, and the cross-sectional area of the nozzle 272, 372, respectively, is also constant along its length. However, the conduit can include one or more section(s) in which the cross-sectional area is not constant along the length of the section(s). For example, FIG. 7 shows conduit 460 including a nozzle 472 in which the cross-sectional area of the conduit 461 changes (increases) along its length in a direction from the inlet end 466 toward the outlet end 468. When the nozzle 472 is used as an exit nozzle to form a portion of the conduit 460, the vapor velocity through the nozzle 472 decreases in the flow direction indicated by the arrow A. Alternatively, the cross-sectional area of the nozzle can decrease along its length (not shown) to increase the exit velocity of the vapor.

In the conduit 460 shown in FIG. 7, the cross-sectional flow area of the nozzle 472 increases continuously along its length. However, the nozzles of conduits can have shapes that provide an increasing or decreasing cross-sectional area of the conduit along the length of the nozzle. For example, as depicted in FIG. 8, the conduit 560 can alternatively have a stepped profile, including a portion in the first section 570 having a smaller cross-sectional area than a portion in the nozzle 572. In this embodiment, the velocity of the vapor decreases as it moves from the inlet end 566 toward the outlet end 568 in the direction indicated by arrow A due to the increasing cross-sectional area of the conduit.

The length of the conduit is equal to the total length of the one or more sections that form it. The conduit can have a length from 0.5 to 10 cm, and preferably from 1 to 4 cm. In conduits 460, 560 shown in FIGS. 7 and 8, respectively, the respective nozzles 472, 572 are sufficiently long to decrease the velocity of the vapor moving in the conduit from a velocity, at which the vapor moves in the first section 470, 570, respectively, to the desired exit velocity at which the vapor exits the conduit at the outlet end of the conduit.

The fluid supplied from the liquid source 106 is heated in the conduit to form a vapor during operation of the fluid vaporizing device 100. As shown in FIG. 9, the capillary 160 can comprise metal tubing heated by passing an electrical current along a length of the capillary via a first electrode 138 and a second electrode 140. However, as described above, the conduit can have other alternative constructions, such as a monolithic or multi-layer construction, which can include a heater comprising resistance heating material positioned to heat the fluid in the conduit. For example, the resistance heating material can be disposed inside of, or exterior to, the conduit.

The conduit 160 may comprise an electrically conductive tube provided with the electrode 138, which is the downstream electrode, and the electrode 140, which is the upstream electrode. Both electrodes are preferably made of copper or a copper-based material. The electrodes and the conduit may be formed from the same or different materials as described above.

The capillary 160 can be a controlled temperature profile construction, such as disclosed in copending and commonly assigned U.S. application Ser. No. 09/957,026, filed Sep. 21, 2001, which is incorporated herein by reference in its entirety. In the controlled temperature profile capillary, the electrode 138 has an electrical resistance sufficient to cause it to be heated during operation of the fluid vaporizing device, thereby minimizing heat loss at the outlet end of the capillary tube.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. A method of manufacturing a fluid delivery component having a capillary-sized fluid delivery conduit comprising the steps of:
molding a template having at least a part thereof corresponding to an internal geometry of the conduit;
coating a layer on an exposed surface of the template; and
removing the template to produce the fluid delivery component.

2. The method of claim 1, wherein the template is injection molded.

3. The method of claim 1, wherein at least a portion of the template is hollow.

4. The method of claim 1, wherein the template is molded to comprise at least one segment having a transverse cross section with an internal dimension less than about 1 mm.

5. The method of claim 1, wherein the template is molded to comprise a segment having a constant and/or variable cross-section.

6. The method of claim 1, wherein the template is molded to include a fluid connection at an upstream end thereof and a nozzle at a downstream end thereof.

7. The method of claim 1, wherein the templates is molded to include a branched flow passage, a flange, a bend and/or electrical connections.

8. The method of claim 1, wherein the exposed surface of the template is cleaned or conditioned before the coating step.

9. The method of claim 1, wherein the template is molded to include a plurality of first sections, each of the first sections having the internal geometry of the conduit and second sections extending from at least one end of the first sections.

10. The method of claim 1, wherein the template further comprises an insert passing through at least a portion of the template.

11. The method of claim 10, wherein the step of removing the template includes heating the insert.

12. The method of claim 1, wherein the template is formed from a polymer material, a low melting temperature metal or an electrically conducting solid.

13. The method of claim 1, wherein the template is formed from a polymer selected from the group consisting thermoplastics, fiber reinforced thermoplastics, thermosetting plastics, cellulose esters, polyesters, co-polyesters, elastomers and mixtures thereof.

14. The method of claim 1, wherein the template is formed from a polymer selected from the group consisting of acrylonitrile butadiene styrene (ABS), acetals, acrylics, polycarbonates, polyesters, polyethylene, fluoroplastics, polyimides, Nylon, waxes, fatty esters, polyphenylene oxides, polypropylenes, polystyrenes, polysulphones, polyvinyl chlorides and mixtures thereof.

15. The method of claim 1, wherein the template is formed from a metal or alloy selected from the group consisting of aluminum, zinc, silver, indium, tin, lead and mixture thereof.

16. The method of claim 1, wherein the layer is deposited to a total thickness of about 50 to 1000 microns.

17. The method of claim 1, wherein a single layer of material is coated on an exposed surface of the template.

18. The method of claim 1, wherein two or more layers of different materials are coated on an exposed surface of the template.

19. The method of claim 1, wherein an activated layer material and/or a structural layer material are coated on an exposed surface of the template.

20. The method of claim 1, wherein the step of removing the template includes heating the layer.

21. The method of claim 19, wherein the activated layer material is selected from the group consisting of cobalt, nickel, copper, rhodium, palladium, silver, iridium, platinum, gold and alloys or combinations thereof.

22. The method of claim 19, wherein the activated layer material is deposited using a method selected from the group consisting of chemical vapor deposition, plasma deposition, electroless plating, and electrophoresis.

23. The method of claim 19, wherein the activated layer material is coated to a thickness of from about 1 to 100 nm.

24. The method of claim 19, wherein the activated layer material forms an inner surface of the conduit.

25. The method of claim 19, wherein the activated layer material comprises a catalytically active material.

26. The method of claim 19, wherein the structural material comprises a metal or a metal alloy or a ceramic material.

27. The method of claim 19, wherein the structural material comprises nickel.

28. The method of claim 19, wherein the structural material is deposited using a method selected from the group consisting of chemical vapor deposition, plasma deposition, electroless plating, electroplating, dip-coating and electrophoresis.

29. The method of claim 1, wherein the step of removing the template comprises high temperature burn-out, de-polymerization, solvation, melting, etching or pyrolysis.

30. A capillary sized tube made by the method recited in claim 1.

31. A fluid vaporizing device comprising the conduit made by the method of claim 1, the conduit having a flow passage therethrough, a fluid connection at an upstream end thereof and a nozzle at a downstream end thereof.

32. The fluid vaporizing device of claim 31, further comprising a liquid source in fluid communication with the fluid connection.

33. The fluid vaporizing device of claim 31, further comprising electrical connections attached to the conduit to form a resistance heater along a portion of the conduit, and a power source supplying electrical power to the electrical connections to heat liquid in a heated portion of the flow passage to produce a vapor.

34. The fluid vaporizing device of claim 31, wherein the nozzle is configured (i) to increase the exit velocity of the vapor such that a mass median aerodynamic diameter of aerosol particles is decreased or (ii) to decrease the exit velocity of the vapor such that the mass median aerodynamic diameter of aerosol particles is increased.

35. The fluid vaporizing device of claim 31, wherein the nozzle and/or flow passage has a variable cross-sectional flow area.

36. The fluid vaporizing device of claim 31, wherein the cross-sectional flow area of the nozzle varies continuously or non-continuously along the length of the nozzle.

37. The fluid vaporizing device of claim 31, wherein the conduit comprises at least one segment having a transverse cross section with an internal dimension less than about 1 mm.

38. The fluid vaporizing device of claim 31, wherein the conduit comprises a segment having a constant and/or variable cross-section.

39. The fluid vaporizing device of claim 31, wherein the conduit includes a fluid connection at an upstream end thereof and a nozzle at a downstream end thereof.

40. The fluid vaporizing device of claim 31, wherein the conduit includes a branched flow passage, a flange, a bend and/or electrical connections.

41. The fluid vaporizing device of claim 31, wherein the conduit has a thickness of from about 50 to 1000 microns.

42. The fluid vaporizing device of claim 31, wherein the conduit comprises a single layer of material.

43. The fluid vaporizing device of claim 31, wherein the conduit comprises two or more layers of different materials.

44. The fluid vaporizing device of claim 31, wherein the conduit comprises an activated layer material and/or a structural layer material.

45. The fluid vaporizing device of claim 44, wherein the thickness of the activated layer material is from about 1 to 100 nm.

46. The fluid vaporizing device of claim 44, wherein the structural layer material comprises nickel.

47. The fluid vaporizing device of claim 31, wherein an inner surface of the conduit comprises cobalt, nickel, copper, rhodium, palladium, silver, iridium, platinum, gold and alloys or combinations thereof.

48. The fluid vaporizing device of claim 31, wherein an inner surface of the conduit comprises a catalytically active material.

49. A method of manufacturing a fluid delivery component comprising the steps of:
molding a template at least a part thereof comprising an internal geometry of a capillary-sized conduit;
coating a layer of a selected material on an exposed surface of the template; and
removing the template to produce the fluid delivery component.

50. A method of manufacturing a fluid delivery component comprising the steps of:
injection molding a template having at least two sections;
coating a layer of material on an exposed surface of said at least two sections; and
removing the template to produce the fluid delivery component;
wherein one of said at least two sections is an internal geometry of a capillary-sized conduit;
wherein one of said at least two sections corresponds to a feed section for said capillary-sized conduit; and
wherein an internal geometry of one of said at least two sections corresponds to an electrical connection to a capillary-sized conduit.
